(19) United States
(12) Patent Application Publication
(10) Pub. No.: US 2015/0356072 A1
(43) Pub. Date: Dec. 10, 2015

(54) Method and Apparatus of Matching Text Information and Pushing a Business Object

(71) Applicant: Alibaba Group Holding Limited, Grand Cayman (KY)

(72) Inventors: Wei He, Hangzhou (CN); Bo Li, Hangzhou (CN); Ke Xie, Hangzhou (CN); Feng Lin, Hangzhou (CN)

(21) Appl. No.: 14/731,305

(22) Filed: Jun. 4, 2015

(30) Foreign Application Priority Data
Jun. 5, 2014 (CN) 201410247068.X

(51) Int. Cl. G06F 17/27

(52) U.S. Cl. CPC G06F 17/27

(57) ABSTRACT

Methods and apparatuses of matching text information and pushing a business object are disclosed. The method of matching text information includes: acquiring a first text information set and a second text information set to be matched, the first text information set including a finite amount of first text information and the second text information set including a finite amount of second text information; and finding one or more pieces of the finite amount of second text information that match with each piece of the finite amount of first text information according to a preset rule. The embodiments of the present disclosure abandon an open-ended expansion approach way of directly searching extended words from the first text information and turns to a closed interval to find one or more pieces of the finite amount of second text information which match with each piece of the finite amount of first text information, thus avoiding an unnecessary amount of matching computation, reducing a waste of system resources and improving an efficiency of matching computation.

### CROSS REFERENCE TO RELATED PATENT APPLICATION

This application claims foreign priority to Chinese Patent Application No. 201410247068.X filed on Jun. 5, 2014, entitled “Method and Apparatus of Matching Text Information and Pushing a Business Object”, which is hereby incorporated by reference in its entirety.

### TECHNICAL FIELD

The present disclosure relates generally to network communications, and in particular to methods of matching text information, methods of pushing a business object, apparatuses of matching text information, and apparatuses of pushing a business object.

### BACKGROUND

With the rapid development of networks, there is a dramatic increase in network information. In order to search desired network information from among massive volumes of network information, a user usually uses a search engine for performing a search.

A search engine refers to a system which automatically gathers information from the Internet and allows users to perform a query after certain manipulation. The network information is vast in amount and is totally unordered. All network information is just like small islands in a vast sea, and webpage links are bridges that are crisscrossed among those small islands. The search engine draws an information map which is clear at a glance for the users, allowing the users to access at any time.

For functions such as related inquires, the search engine usually executes a specific strategy of rewriting query terms to rewrite a query term Q inputted by a user to extend the query term to a similar term Q′ (i.e., an extended term) which has the same or similar query intention. Normally, Q′ is an extended word that needs to be bound to a business object. Otherwise, an objective to resolve insufficient exposure of the business object cannot be achieved. Therefore, the search engine often first rewrites Q into Q′ using various rewriting strategies, and then removes ineffective extended words (i.e., extended words which are not bound to the business object) from Q′, reserving a set of effective extended words (i.e., extended words which are bound to the business object).

Extension technologies for rewriting a query term Q inputted by a user to extend it to a similar term Q′ which has the same or similar query intention thereof mainly include:
1. determining a content similarity (Content Based) between query terms based on whether the two query terms have a same token that is matched, and rewriting Q into Q′.
2. determining a semantic similarity (Syntax Based) between query terms based on whether the two query terms have the same key term or product term, and rewriting Q into Q′.
3. determining a user behavior correlation degree (Session Based) between query terms based on whether the two query terms occur in the same user click stream, and rewriting Q into Q′.
4. determining a document aggregation degree (Document Based) between query terms based on a number of documents clicked by users that are the same for the two query terms, and rewriting Q into Q′.

However, in the above-mentioned four extension technologies, a computation amount of ineffective extended words in <Q, Q′> extended pairs is unnecessarily increased, and a large amount of system resources is wasted.

In addition, since internal computation mechanisms are different in the above-mentioned four extension technologies, extended measures of correlation between Q and Q′ are not consistent, and thus <Q, Q′> extended pairs cannot be evaluated.

Therefore, a technical problem which needs to be solved by one skilled in the art is: how to provide a matching of text information to reduce an amount of computation for matching, reduce a waste of system resources and unify an evaluation measure.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The technical problem to be solved by embodiments of the present disclosure is to provide a method of matching text information and a method of pushing a business object to reduce a computation amount for matching, reduce waste of system resources and unify an evaluation measure.

Correspondingly, the embodiments of the present disclosure further provide an apparatus of matching text information and an apparatus of pushing a business object to ensure an implementation and an application of the above-mentioned methods.

In order to solve the above-mentioned problem, the embodiments of the present disclosure provide a method of matching text information, which includes:

acquiring a first text information set and a second text information set to be matched; the first text information set including a finite amount of first text information, the second text information set including a finite amount of second text information; and

finding one or more pieces of the finite amount of second text information which is matched with each piece of the amount volume of first text information according to a preset rule.

In an embodiment, the first text information and the second text information have corresponding categories.

Finding the one or more pieces of the finite amount of second text information which is matched with each piece of the finite amount of first text information according to the preset rule includes:

combining the first text information and the second text information into an extended text information combination according to a preset combination rule;

extracting characteristic text information combination from the extended text information combination, the characteristic text information combination being a combination of extended text information that is formed from first text information and second text information having a matched category;

computing characteristic values of pieces of the second text information included in the characteristic text information combination; and

setting one or more pieces of the second text information having a respective characteristic value ranked at the front and a corresponding piece of the first text information as mutually mapped pair of first text information and second text information.

In an embodiment, combining the first text information and the second text information into the extended text information combination according to the preset combination rule includes:

conducting a word segmentation for the first text information to acquire a segmented text term;

establishing an inverted index for the second text information;

finding second text information which is matched with the segmented text term from the inverted index; and

combining the first text information to which the segmented text term belongs and the matched second text information into the extended text information combination.

In an embodiment, combining the first text information and the second text information into the extended text information combination according to the preset combination rule further includes:

conducting a de-duplication processing for the second text information which is matched with the segmented text term.

Combining the first text information to which the segmented text term belongs and the matched second text information into the extended text information combination includes:

combining the first text information to which the text segmented word belongs and the de-duplicated second text information into the extended text information combination.

In an embodiment, categories corresponding to the first text information include first child categories and first parent categories, and categories corresponding to the second text information include second child categories and second parent categories.

Extracting the characteristic text information combination from the extended text information combination includes:

acquiring one or more of the first child categories having a respective confidence level ranked at the front and corresponding to the first text information included in the extended text information combination;

finding one or more of the first parent categories having a respective confidence level ranked at the front, to which the one or more of the first child categories belong;

acquiring one or more of the second child categories having a respective confidence level ranked at the front and corresponding to the second text information included in the extended text information combination;

searching one or more of the second parent categories having a respective confidence level ranked at the front, to which the one or more of the second child categories belong; and

extracting a combination of extended text information having a match of a first child category and a second child category, the first child category and the second parent category, and/or a first parent category and the second child category as the characteristic text information combination.

In an embodiment, the second text information has a corresponding business object.

The characteristic value of the second text information included in the characteristic text information combination is computed through the following equation:

RPM1=ASN*CPC

where RPM1 is the characteristic value, ASN is a user depth corresponding to the business object and CPC is a weight corresponding to the business object.

In an embodiment, the finite amount of first text information includes query terms acquired in a certain time period and the finite amount of second text information includes bid terms acquired in a certain period of time.

The embodiments of the present disclosure further disclose a method of pushing a business object, which includes:

receiving first text information submitted from a client side;

determining second text information to which the first text information is mapped; the second text information having a corresponding business object; and

pushing the business object to the client side,

wherein a mapping relationship between the first text information and the second text information is determined by:

acquiring a first text information set and a second text information set to be matched; the first text information set including a finite amount of first text information, the second text information set including a finite amount of second text information; and

finding one or more pieces of the finite amount of second text information which is matched with each piece of the finite amount of first text information according to a preset rule.

In an embodiment, determining the second text information to which the first text information is mapped includes:

online computing the second text information to which the first text information is mapped.

In an embodiment, determining the second text information to which the first text information is mapped includes:

searching the second text information to which the first text information is mapped from a preset mapping relationship dictionary, the mapping relationship dictionary being a dictionary which is generated by offline computing the second text information to which the first text information is mapped.

The embodiments of the present disclosure further disclose an apparatus of matching text information, which includes:

a text information acquisition unit to acquire a first text information set and a second text information set to be matched, the first text information set including a finite amount of first text information, and the second text information set including a finite amount of second text information; and

a text information matching unit to find one or more pieces of the finite amount of second text information which is matched with each piece of the finite amount of first text information according to a preset rule.

In an embodiment, the first text information and the second text information have corresponding categories.

The text information matching unit includes:

an extended text information combination formation module to combine the first text information and the second text information into an extended text information combination according to a preset combination rule;

a characteristic text information combination extraction module to extract characteristic text information combination from the extended text information combination, the characteristic text information combination being a combination of extended text information formed from matched categories of the first text information and the second text information;

a characteristic value computation module to compute characteristic values of pieces of second text information included in the characteristic text information combination; and

a mapping relationship setting module to set one or more pieces of second text information having a respective characteristic value ranked at the front and a corresponding piece of first text information as first text information and second text information being mapped to each other.

In an embodiment, the extended text information combination formation module includes:

a word segmentation sub-module to conduct a word segmentation for the first text information to acquire a segmented text term;

an index sub-module to establish an inverted index for the second text information;

a first searching sub-module to find second text information which is matched with the segmented text term from the inverted index; and

a formation sub-module to combine the first text information to which the text segmented word belongs and the matched second text information as the extended text information combination.

In an embodiment, the extended text information combination formation module further includes:

a de-duplication sub-module to conduct a de-duplication processing for the second text information which is matched with the segmented text term.

The formation sub-module includes:

a de-duplication combination sub-module to combine the first text information to which the segmented text term belongs and the de-duplicated second text information as the extended text information combination.

In an embodiment, categories corresponding to the first text information include first child categories and first parent categories, and categories corresponding to the second text information include second child categories and second parent categories.

The characteristic text information combination extraction module includes:

a first acquisition sub-module to acquire one or more of the first child categories having a respective confidence level ranked at the front and corresponding to the first text information included in the extended text information combination;

a second searching sub-module to search one or more of the first parent categories having a respective confidence level ranked at the front, to which the one or more of the first child categories belong;

a second acquisition sub-module to acquire one or more of the second child categories having a respective confidence level ranked at the front and corresponding to the second text information included in the extended text information combination;

a third searching sub-module to search one or more of the second parent categories having a respective confidence level ranked at the front, to which the one or more of the second child categories belong; and

an extraction sub-module to extract a combination of extended text information formed from a match of the first child categories and the second child categories, the first child categories and the second parent categories, and/or the first parent categories and the second child categories as the characteristic text information combination.

In an embodiment, the second text information corresponds to a business object.

The characteristic value of the second text information included in the characteristic text information combination is computed through the following equation:

RPM1=ASN*CPC

where RPM1 is the characteristic value, ASN is a user depth corresponding to the business object and CPC is a weight corresponding to the business object.

In an embodiment, the finite amount of first text information includes query terms acquired in a certain time period and the finite amount of second text information includes bid terms acquired in a certain period of time.

The embodiments of the present disclosure further disclose an apparatus of pushing a business object, which includes:

a text information receiving unit to receive first text information submitted from a client side;

a text information determination unit to determine second text information to which the first text information is mapped, the second text information corresponding to a business object; and

a business object push unit to push the business object to the client side,

wherein a mapping relationship between the first text information and the second text information is determined by invoking:

a text information acquisition unit to acquire a first text information set and a second text information set to be matched, the first text information set including a finite amount of first text information, and the second text information set including a finite amount of second text information; and

a text information matching unit to find one or more pieces of the finite amount of second text information which is matched with each piece of the finite amount of first text information according to a preset rule.

In an embodiment, the text information determination unit includes:

an online computation module to compute the second text information to which the first text information is mapped on-line.

In an embodiment, the text information determination unit includes:

a dictionary searching module to search the second text information to which the first text information is mapped from a preset mapping relationship dictionary, wherein the mapping relationship dictionary is a dictionary generated by computing the second text information to which the first text information is mapped off-line.

Compared with existing technologies, the embodiments of the present disclosure include the following advantages:

The embodiments of the present disclosure abandon an open-ended extension approach of searching extended words directly from first text information, and turn to a closed interval to search one or more pieces of a finite amount of second text information that matches with each piece of a finite amount of the first text information, thus avoiding an unnecessary amount of matching computation, reducing a waste of system resources and improving an efficiency of matching computation.

The embodiments of the present disclosure combine first text information and second text information into an extended text information combination according to a preset combination rule, and extract an extended text information combination that is formed by first text information and second text information having a matched category from the extended text information combination, which abandons an open-ended extension approach of searching extended words directly from the first text information and turns to a closed interval to reserve one or more results with optimal characteristic values of the second text information from the combination of the first text information and the second text information. As such, this ensures that the second text information can be called back while preventing undesired second text information from being called back, thus further avoiding the unnecessary amount of matching computation, reducing the waste of system resources and improving the efficiency of matching computation.

The embodiments of the present disclosure use a characteristic value as a standard for selecting second text information, which provides a unified evaluation measure, thus ensuring that the second text information selected under such evaluation measure is globally optimal.

### DESCRIPTION OF THE DRAWINGS

FIG. 1 is a flowchart of an example method of matching text information according to the present disclosure.

FIGS. 2A-D are flowcharts illustrating another example method of matching text information according to the present disclosure.

FIGS. 3A-F are flowcharts illustrating an example method of pushing a business object according to the present disclosure.

FIG. 4 is a structural diagram of an example apparatus of matching text information according to the present disclosure.

FIG. 5 is a structural diagram of an example apparatus of pushing a business object according to the present disclosure.

### DETAILED DESCRIPTION

In order to make the above-mentioned objectives, characteristics and advantages of the present disclosure clearer and easy to understand, the present disclosure will further be described in detail herein in combination with the accompanying drawings and exemplary embodiments.

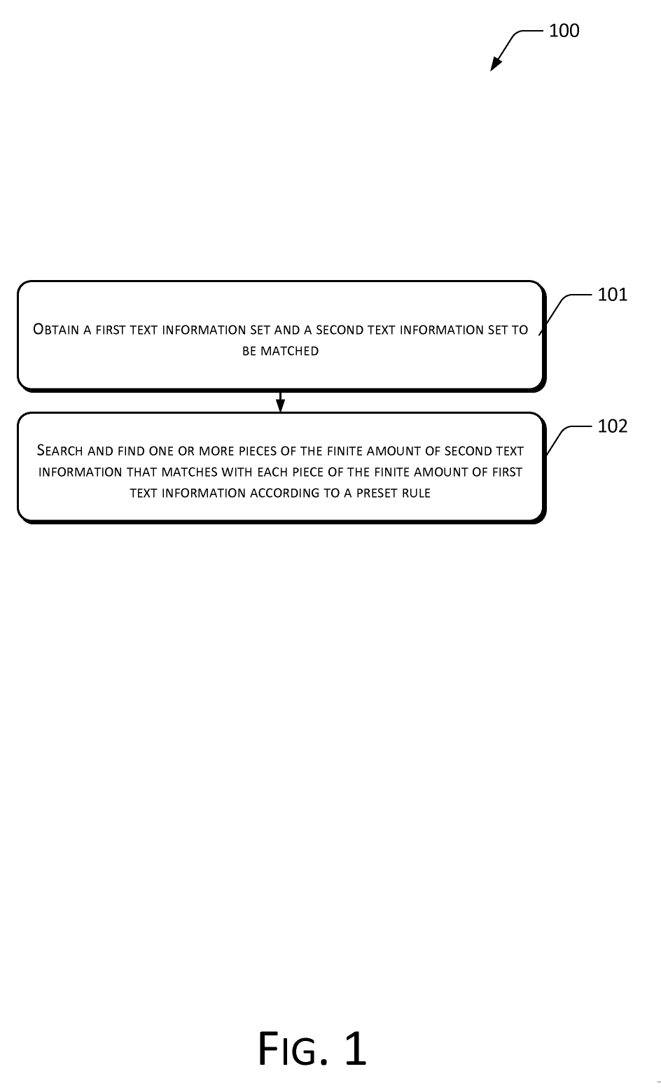

FIG. 1 illustrates a flowchart of an example method 100 of matching text information according to the present disclosure. The method 100 may include:

Block 101 obtains a first text information set and a second text information set to be matched. The first text information set may include a finite amount of first text information and the second text information set may include a finite amount of second text information.

Block 102 searches and finds one or more pieces of the finite amount of second text information that matches with each piece of the finite amount of first text information according to a preset rule.

The existing technologies adopt an open-ended matching mechanism which rewrites a query term Q inputted by a user, extends thereof to a similar word Q′ having a same or similar query intention, and thereby selects effective extended words. However, the query term inputted by the user is unknown, which may result in an unlimited number of times of rewriting. Furthermore, since the number of effective extended words is finite, a computation amount associated with ineffective extended words in <Q, Q′> extended pairs is unnecessarily increased, wasting a large amount of system resources.

The embodiment of the present disclosure adopts a closed approach to find one or more pieces of a finite amount of second text information that matches with each piece of a finite amount of first text information, thus avoiding an unnecessary amount of matching computation, reducing a waste of system resources and improving an efficiency of the matching computation.

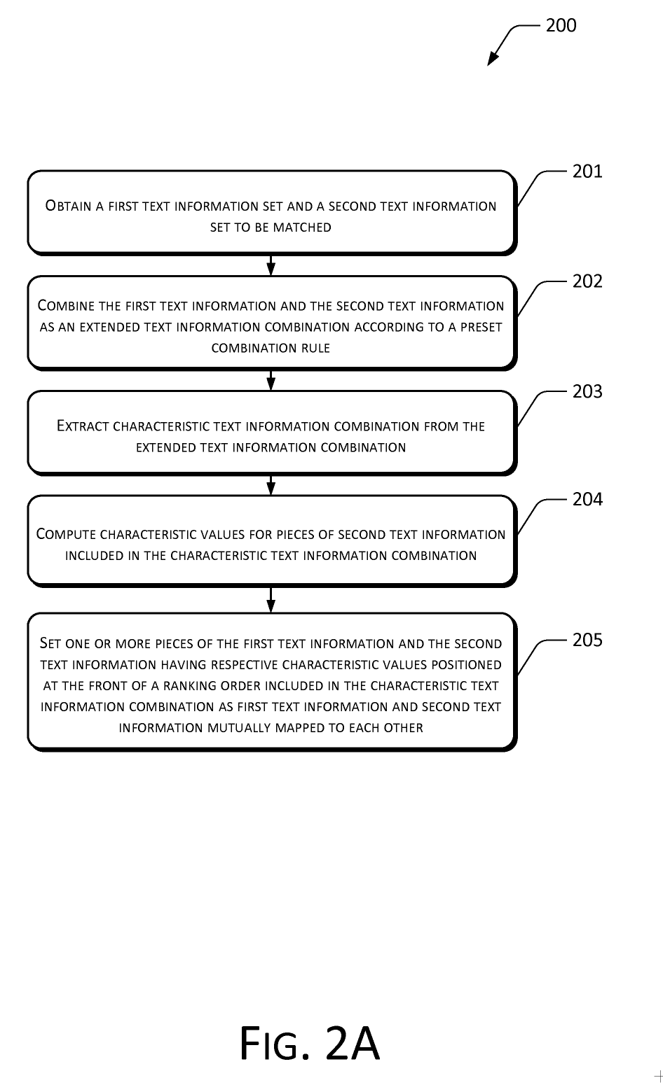

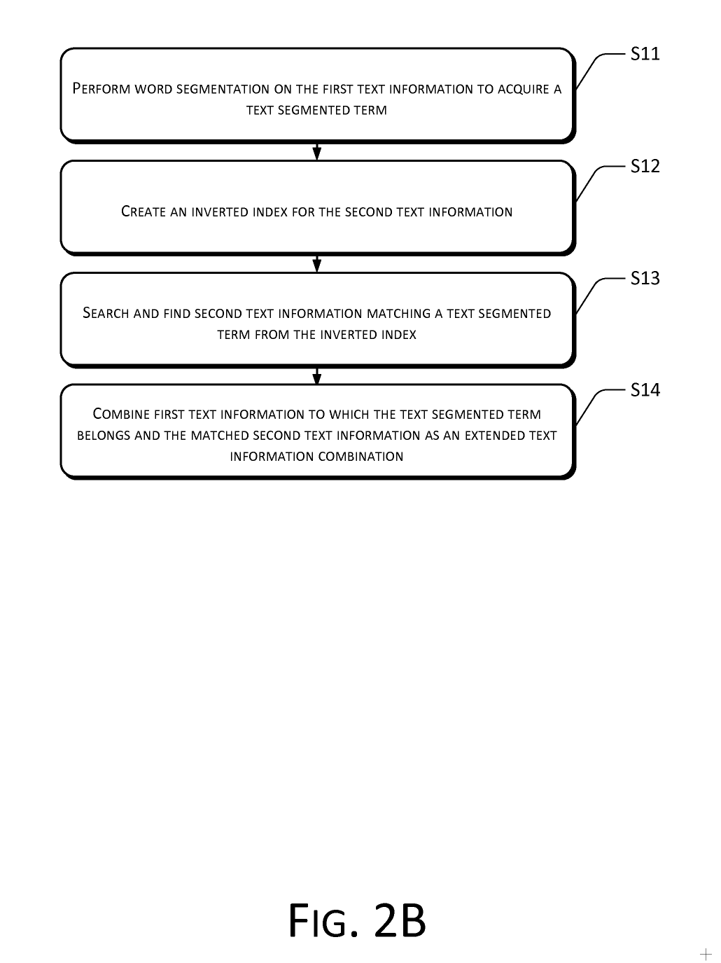

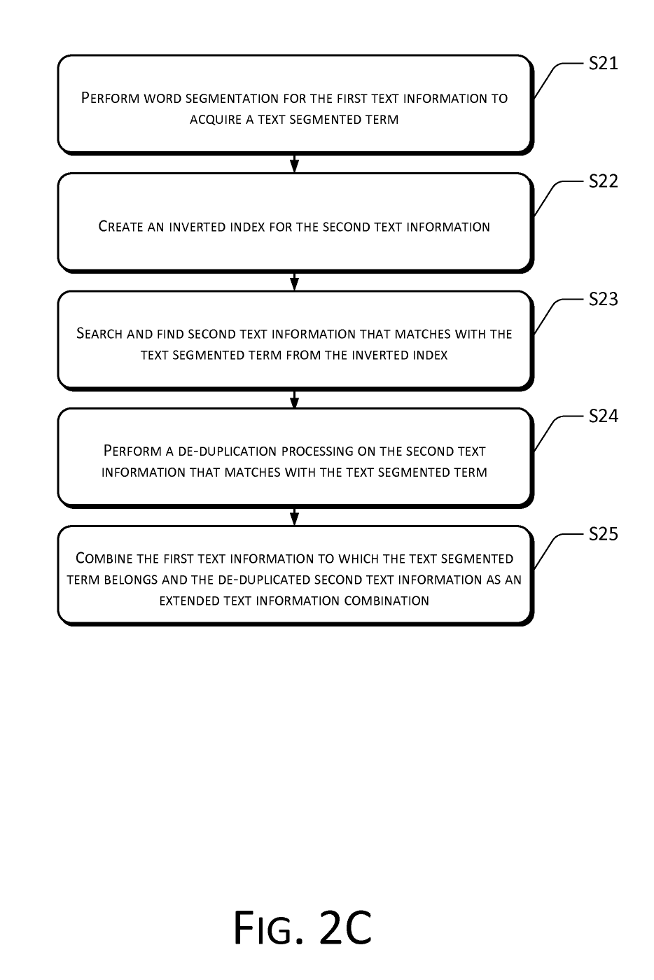

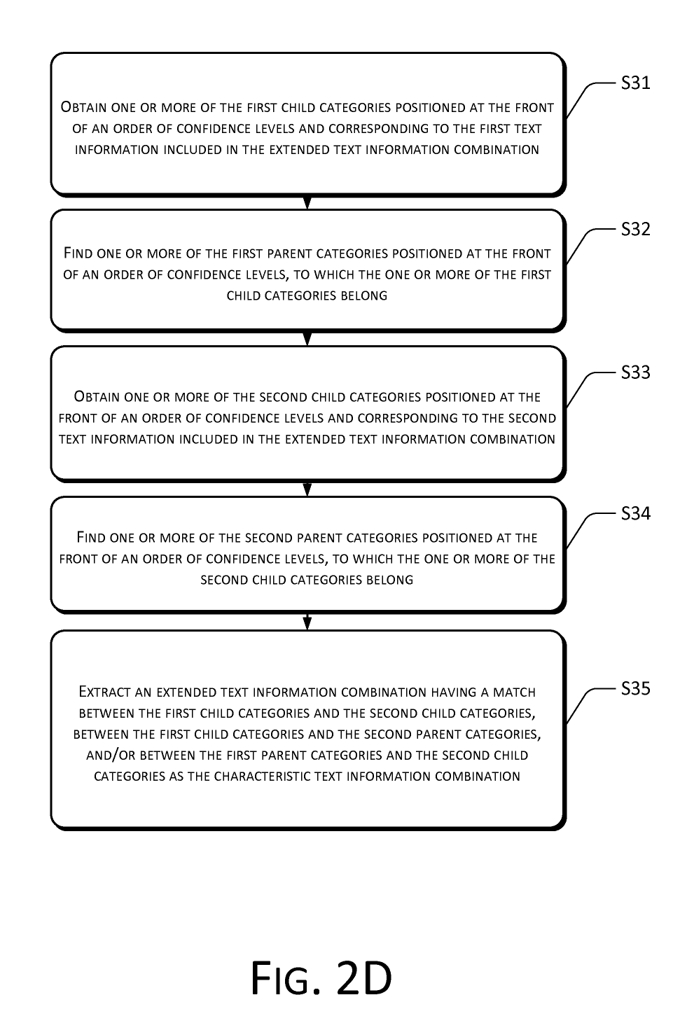

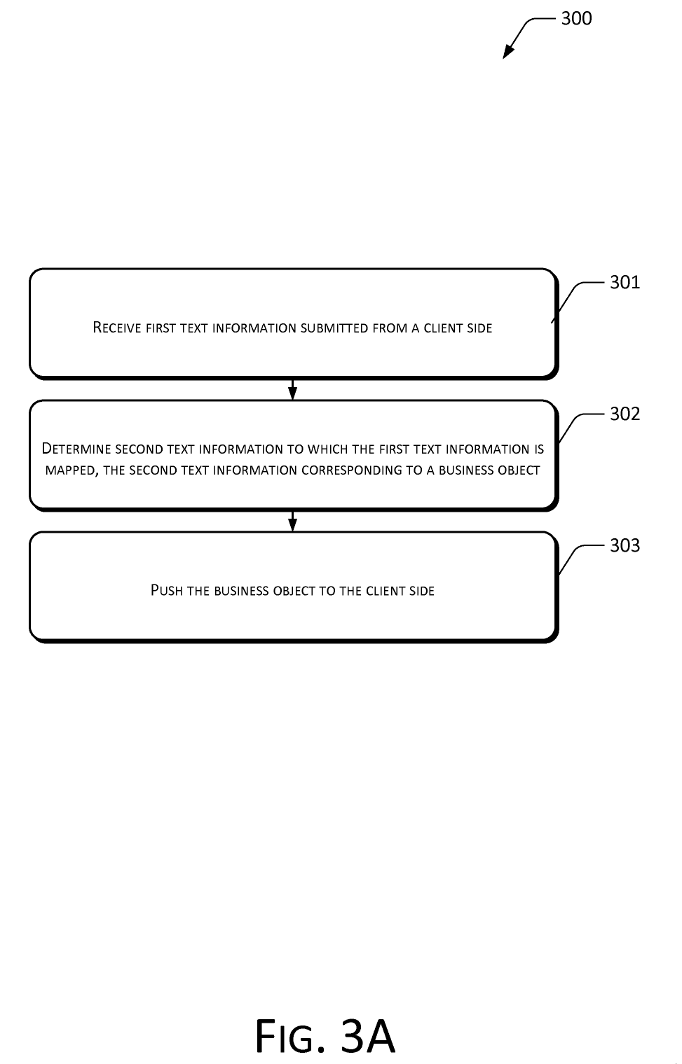

FIG. 2A illustrates a flowchart of another example method 200 of matching text information according to the present disclosure. The method 200 may include:

Block 201 obtains a first text information set and a second text information set to be matched.

In an application of the embodiment of the present disclosure, the first text information set and the second text information set may be acquired in advance and stored in a database. The first text information set and the second text information may then be extracted from the database when a matching is performed.

An advertisement system of electronic commerce (EC) is used as an example. The advertisement system may store advertisement data and bid terms associated with an advertiser and provide searching and corresponding advertisement data presentation services to users.

In this example, the first text information set may be a set of query terms submitted by user(s) (i.e., a finite amount of first text information may include query terms acquired in a certain time period and the query terms may be terms which are inputted by user(s) in search box(es) for querying network information associated therewith), for example, a set formed by query terms submitted by the user(s) within the last month to reflect the interest tendency of the user(s).

The second text information set may be a set of bid terms (i.e., bidwords), or in other words, a finite amount of second text information may include bid terms that are acquired in a certain period of time. The bid terms may be terms purchased by the advertiser for the advertisement data. A user searches and finds the advertisement data (causing exposure) of the advertiser through the bid terms, and conducts a click operation. The advertisement system may then deduct an advertisement fee for a single click from an account of the advertiser according to a price for the bid terms purchased by the advertiser.

In a real application, the query terms may not be the bid terms purchased by the advertiser. Therefore, in the advertisement system for electronic commerce, a query word Q is usually rewritten as an expanded word Q′. To increase the exposure of the advertisement data, the expanded word Q′ typically is a bid term which is bound to the advertisement data.

Block 202 combines the first text information and the second text information as an extended text information combination according to a preset combination rule.

In this embodiment of the present disclosure, a combination rule that selectively combines the first text information and the second text information may be set up in advance.

In an exemplary embodiment of the present disclosure, block 202 may include the following sub-blocks (as shown in FIG. 2B):

Sub-block S11 performs word segmentation on the first text information to acquire a segmented text term.

Commonly used word segmentation methods are introduced as follows:

1. A word segmentation method based on character string matching, corresponds to a process of matching a Chinese character string to be analyzed with entries in a preset machine dictionary according to a certain strategy. If a certain character string is found in the dictionary, an associated matching is successful (i.e., a term is recognized). A real word segmentation system often uses mechanical word segmentation as an initial means of segmentation, and a variety of other language information is also needed to further improve an accuracy of segmentation.

2. A word segmentation method based on feature scanning or symbol segmentation, corresponds to a process of prioritizing recognition and segmentation of some terms having prominent characteristics from a character string to be analyzed, and segmenting the original character string into smaller strings for mechanical word segmentation using these terms as breakpoints to reduce an error rate of matching; or combining word segmentation with word class tagging, using rich word class information to facilitate a word segmentation strategy, and checking and adjusting word segmentation results in turn during a process of tagging to improve an accuracy of segmentation.

3. A word segmentation method based on understanding, corresponds to a process of achieving an effect of word recognition through a computer simulation of human understanding of a sentence. Its basic idea is to simultaneously conduct syntax and semantic analysis during word segmentation and to process ambiguity phenomena using syntax information and semantic information. This method usually includes three parts: a word segmentation subsystem, a syntax and semantic subsystem and a main control component. Under coordination of the main control component, the word segmentation subsystem may acquire syntax and semantic information related to words and sentences to perform a judgment on an ambiguity in the word segmentation, i.e., simulating a process of human understanding of the sentences. This type of word segmentation method needs to use a large amount of language knowledge and information.

4. A word segmentation method based on statistics, corresponds to computing statistics of frequencies of various combinations of adjacent and co-appeared characters in a corpus since the frequencies or probabilities of the adjacent and co-appeared characters in Chinese information may better reflect confidence levels of respective terms, computing co-appearance information thereof and computing an adjacent and co-appearance probability of two Chinese characters X and Y. The co-appearance information may reflect a degree of closeness associated with a binding relationship between Chinese characters. When the degree of closeness is higher than a certain threshold, such character set may be considered as a phrase. This method only needs to conduct statistics about respective frequencies of character sets in the corpus and does not need a segmentation dictionary.

Given queries as an example of the first text information, segmented text terms obtained therefor after word segmentation may include:

<query 1, segmented text term 1, segmented text term 2, . . . , segmented text term n>

<query 2, segmented text term 3, segmented text term 4, . . . , segmented text term m>

For example, after a query “blue mp3 player” is read, word segmentation is conducted. The current English phrase may undergo word segmentation based on a space (or consecutive spaces). Segmented text terms obtained after the word segmentation may be “blue”, “mp3” and “player”.

Sub-block S12 creates an inverted index for the second text information.

In a real application, each entry in the inverted index may include an attribute value and each recorded address having that attribute value. Since the attribute value is not determined by a recorded position but the recorded position is determined by the attribute value, the index is therefore referred to as an inverted index.

A file with an inverted index is called as an inverted index file, or abbreviated as an inverted file. Index objects thereof include words in documents or document sets (such as bid terms).

Bid terms are used as an example of the second text information. After an inverted index is created, an inverted index file may be shown as follows:

<term 1, bid term 1, bid term 2, . . . , bid term n>

<term 2, bid term 3, bid term 4, . . . , bid term m>

where a term may be a word included in the bid terms.

Sub-block S13 searches and finds second text information matching a segmented text term from the inverted index.

In a specific implementation, an attribute value (such as a term) which is matched with a segmented text term may be found. Second text information which matches with text information, i.e., second text information returned by the first text information, may be determined according to a mapping relationship between the attribute values (such as terms) and the recorded addresses (such as bid terms).

An advertisement system for electronic commerce is used as an example. A bid term set B1, which includes three bid terms: “red mp3”, “black mp3” and “ipod mp3 player”, is assumed to exist.

Using the embodiment of the present disclosure, the bid term “red mp3”, which is formed by two words “red” and “mp3”, may be processed first. An inverted index may be established as follows:

red->red mp3

mp3->red mp3

In other words, the bid term “red mp3” may be found through either the word “red” or the word “mp3”.

Similarly, after “black mp3” is processed, an inverted index may be shown as follows:

red->red mp3

black->black mp3

mp3->red mp3, black mp3

Similarly, after “ipod mp3 player” is processed, an inverted index may be shown as follows:

ipod->ipod mp3 player

red->red mp3

black->black mp3

player->ipod mp3 player

mp3->red mp3, black mp3, ipod mp3 player

After a query “blue mp3 player” is read, word segmentation is first performed. The current English may undergo word segmentation based on a space (or consecutive spaces). Segmented text terms obtained after the word segmentation in this example may be “blue”, “mp3” and “player”.

Then, matching bid terms may then be searched from the inverted index of B1 by using “blue”, “mp3” and “player” respectively.

Since “blue” does not have a hit in the inverted index, an association among “mp3”, “player” and the index has a structure as follows:

mp3->red mp3, black mp3, ipod mp3 player

player->ipod mp3 player

Therefore, a final bid term set associated with the query “blue mp3 player” through term matching after the word segmentation is given as follows:

blue mp3 player->red mp3, black mp3, ipod mp3 player, ipod mp3 player

For another example, if a query is “women dress”, segmented text terms obtained after word segmentation may be “women” and “dress”. Therefore, in the inverted index generated by B1, each segmented text term cannot be associated with any bid term, and thus no bid term is returned by “women dress”.

Sub-block S14 combines first text information to which the segmented text term belongs and the matched second text information as an extended text information combination.

In a specific implementation, a matching relationship between the first text information and the second text information may be determined using the extended text information combination.

Bid terms are used as an example of the second text information. In response to forming the extended text information combination, an extended text information combination may be given as follows:

<query 1, bid term 2>
<query 2, bid term 5>
...
<query m, bid term n>

In an exemplary embodiment of the present disclosure, block 202 may include sub-blocks as follows (as shown in FIG. 2C):

Sub-block S21 performs word segmentation for the first text information to acquire a segmented text term.

Sub-block S22 creates an inverted index for the second text information.

Sub-block S23 searches and finds second text information that matches with the segmented text term from the inverted index.

Sub-block S24 performs a de-duplication processing on the second text information that matches with the segmented text term.

Sub-block S25 combines the first text information to which the segmented text term belongs and the de-duplicated second text information as an extended text information combination.

In a specific implementation, since a part of the second text information may be called back repetitively, a de-duplication processing is needed at this point.

For example, “ipod mp3 player” in B1 is called back once by the words “mp3” and “player” respectively in the above example. Thus, a de-duplication processing is needed. Therefore, “blue mp3 player” actually returns three bid terms: “red mp3”, “black mp3” and “ipod mp3 player”.

Block 203 extracts characteristic text information combination from the extended text information combination, the characteristic text information combination being an extended text information combination formed by the first text information and the second text information having a matched category.

In a specific implementation, the first text information and the second text information may have categories corresponding thereto. Categories corresponding to the first text information may include first child categories and first parent categories, and categories corresponding to the second text information may include second child categories and second parent categories.

In an exemplary embodiment of the present disclosure, block 203 may include the following sub-blocks (as shown in FIG. 2D):

Sub-block S31 obtains one or more of the first child categories positioned at the front of an order of confidence levels and corresponding to the first text information included in the extended text information combination.

Sub-block S32 finds one or more of the first parent categories positioned at the front of an order of confidence levels, to which the one or more of the first child categories belong.

Sub-block S33 obtains one or more of the second child categories positioned at the front of an order of confidence levels and corresponding to the second text information included in the extended text information combination.

Sub-block S34 finds one or more of the second parent categories positioned at the front of an order of confidence levels, to which the one or more of the second child categories belong.

Sub-block S35 extracts an extended text information combination having a match between the first child categories and the second child categories, between the first child categories and the second parent categories, and/or between the first parent categories and the second child categories as the characteristic text information combination.

In the embodiment of the present disclosure, category results of the first text information (such as a query) and each candidate piece of second text information (such as a bid term) corresponding to the first text information (such as the query) are predicted, and candidate bid terms therein which do not match with the categories of the first text information (such as the query) may be filtered out.

In an implementation, category prediction may adopt a learning-to-rank (L2R) algorithm to rank candidates of first child categories of first text information (such as a query), and a training may be performed based on a statistical characteristic of the first text information (such as the query) under the first child categories and RankSVM (Rank Space Vector Model) weights to compute correlation scores of the first text information (such as the query) under the first child categories.

In the category prediction, first child categories corresponding to first N (N is a positive integer such as three) number of the highest confidence levels with respect to each piece of first text information (such as a query) are given. Thereafter, based on a mapping relationship of a predefined parent-and-child category relationship tree <child categories, parent categories>, respective first parent categories M (M is a positive integer such as three) number of highest confidence levels of the N number of first child categories are found.

Similarly, for the second text information (such as bid terms), Y (Y is a positive integer such as three) number of second parent categories corresponding to X (X is a positive integer such as three) number of second child categories respectively may be acquired.

Then, the first parent categories and the first child categories corresponding to the first text information (such as the query) and the second parent categories and the second child categories corresponding to the second text information (such as the bid terms) are computed respectively to check whether a matched category exists therebetween. If no match is found, the first text information and the second text information is dropped or filtered out. Furthermore, in an event of child-child category matching, child-parent category matching and parent-child category matching, the first text information and the second text information is maintained. In some embodiments, a parent-parent category matching may be considered as a weak relation and thus, the first text information and the second text information can be dropped or filtered out.

A matching principle may be given as shown in the following table:

| Category | Second child | Second parent |
|---|---|---|
| matching principles | categories | categories |
| First child categories | ✓ | ✓ |
| First parent categories | ✓ | X |

“✓” may represent “maintained” and
“X” may represent “filtered out”.

For example, child categories corresponding to first three highest confidence levels computed by the category prediction of first text information “ipod mp3 player” are C1, C2 and C3 respectively, and respective parent categories corresponding to C1, C2 and C3 are PC1, PC2 and PC3.

Similarly, child categories corresponding to first three highest confidence levels with respect to second text information “blue mp3 player” that is returned by “ipod mp3 player” are D1, D2 and D3 respectively, and respective parent categories corresponding to D1, D2 and D3 are PD1, PD2 and PD3.

If C1 is matched with D2 or C2 is matched with D3, this may be called as a child-child category matching. If C1 is matched with PD3 or PC3 is matched with PD2, this may be called as a child-parent category matching. If PC2 is matched with D3, this may be called as a parent-child category matching. If PC2 is matched with PD3, this may be called as a parent-parent category matching.

Block 204 computes characteristic values for pieces of second text information included in the characteristic text information combination.

In an embodiment of the present disclosure, characteristic values of pieces of the second text information (such as bid terms) may be computed based on characteristic text information that is formed by pieces of the first text information (such as a query) and the pieces of the second text information (such as the bid terms) that remain. The characteristic values may be numerical values that reflect characteristics of the second text information included in the characteristic text information combination, and may be set up by one skilled in the art according to actual second text information. For example, characteristic values may be revenue indexes in an advertisement system for electronic commerce.

In a specific implementation, the second text information may have a corresponding business object, and may have different business objects in different business fields. For example, in an advertisement system for electronic commerce, business objects may be advertisement data.

In an implementation, a characteristic value of a characteristic text information combination may be computed using an equation as follows:

RPM1=ASN*CPC

where RPM1 is a characteristic value, ASN is a user depth corresponding to a business object, and CPC is a weight corresponding to the business object.

The user depth may be used to represent a degree of user preference with respect to a business object. For example, in an advertisement system for electronic commerce, ASN may be an indicator that indicates how many advertisers purchase a bid term, and may be represented by a number of advertisers (such as a number of advertisers on a previous day) who purchase the bid term.

The weight may be set by one skilled in the art according to a business object in reality. For example, in an advertisement system for electronic commerce, CPC may be an average unit price associated with clicking of advertisement data.

An advertisement system for electronic commerce is used as an example. A real revenue index RPM1=COV*CTR2*CPC, where COV is a coverage rate which is a division between a flow of advertisement data which enters the advertisement system and has been presented and all flows that enter the advertisement system, and CTR2 is a click rate which is a division between effective clicks of advertisement data and exposure of advertisement data.

In a real application, RPM1=ASN*CPC may be used as an estimated revenue index, i.e., realizing maximization of RPM1 through maximization of ASN*CPC fitting. This is because an increase in a user depth ASN (i.e., an increase in an amount of advertisement data presented on a search page) will increase CTR2 (the more the advertisement data is presented on the webpage, the greater the probability of clicking is) under a condition that a respective click rate of each piece of the advertisement data does not change. Therefore, under a situation that ASN is not saturated, CTR2 may be improved indirectly by increasing ASN.

Block 205 sets one or more pieces of the first text information and the second text information having respective characteristic values positioned at the front of a ranking order included in the characteristic text information combination as first text information and second text information mutually mapped to each other.

In an embodiment of the present disclosure, one or more pieces of second text information with the highest characteristic values and first text information corresponding to the second text information may be selected as final text information pair(s) mutually mapped to each other.

An advertisement system for electronic commerce is used as an example. First text information and second text information may be mapped to each other in a form as follows:

<query 1, bid term 2=180, bid term 122=150, ... , bid term 30=72>
...
<query m, bid term 90=350, bid term 46=330, ... , bid term 55=280>

where numerical values such as “180” and “150” after bid terms may be numerical values of revenue indexes RPM1 of the bid terms.

In the advertisement system for electronic commerce, an embodiment of the present disclosure may be used for unifying an evaluation standard <query Q, bid term B>, and ensuring maximization of advertisement data revenue through maximization of a user depth ASN and an average click unit price CPC from a global <query Q, bid term B> pair set.

An embodiment of the present disclosure combines first text information and second text information into an extended text information combination according to a preset combination rule, and extracts an extended text information combination formed by first text information and second text information having a matched category from the extended text information combination, which adopts a closed approach to maintain one or more results with optimal characteristic values of the second text information from the combination of the first text information and the second text information. This ensures that the second text information may be called back while preventing undesired second text information from being called back, thus further avoiding an unnecessary amount of matching computation, reducing a waste of system resources and improving an efficiency of matching computation.

An embodiment of the present disclosure uses a characteristic value as a standard for selecting the second text information, which provides a unified evaluation measure and ensures that the second text information selected under such evaluation measure is globally optimal.

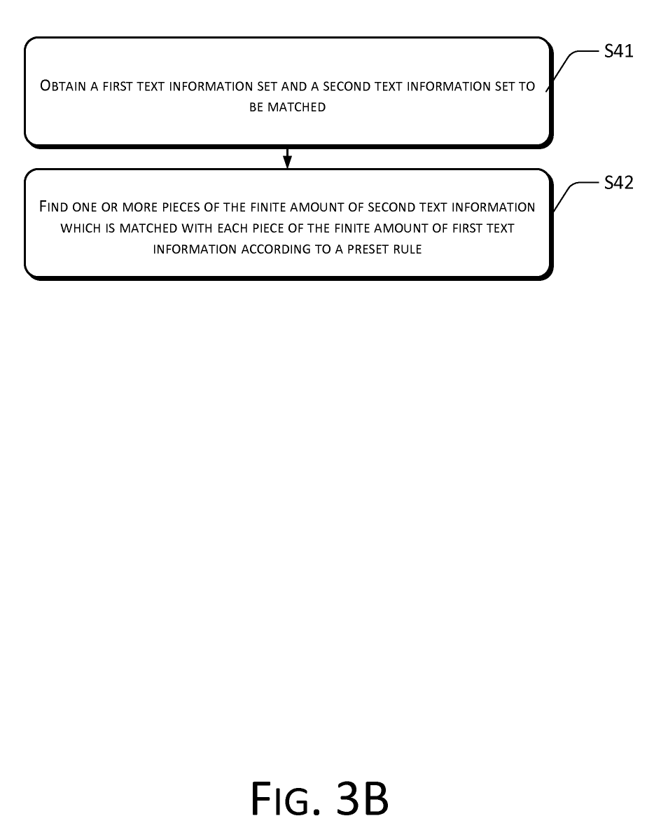

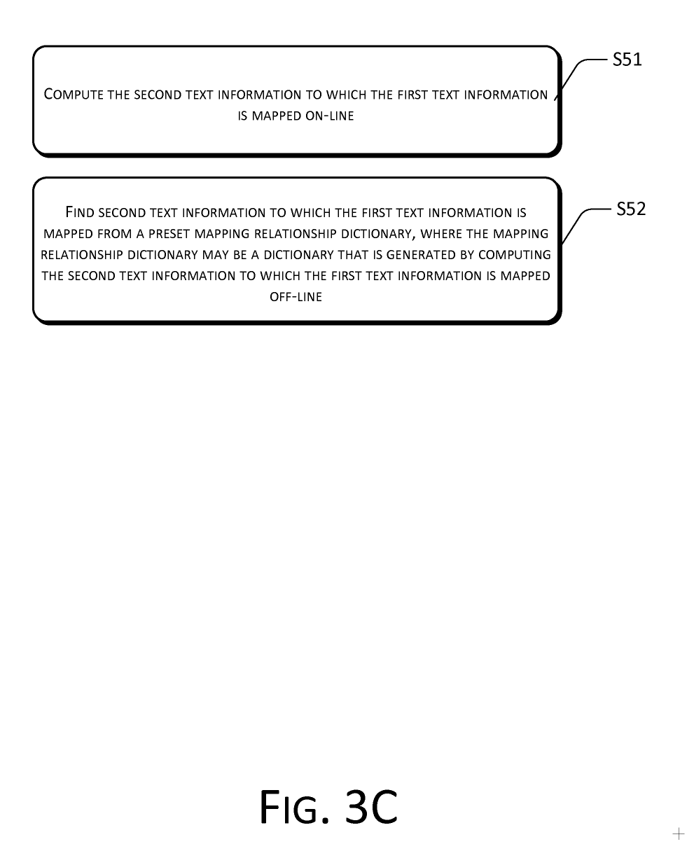

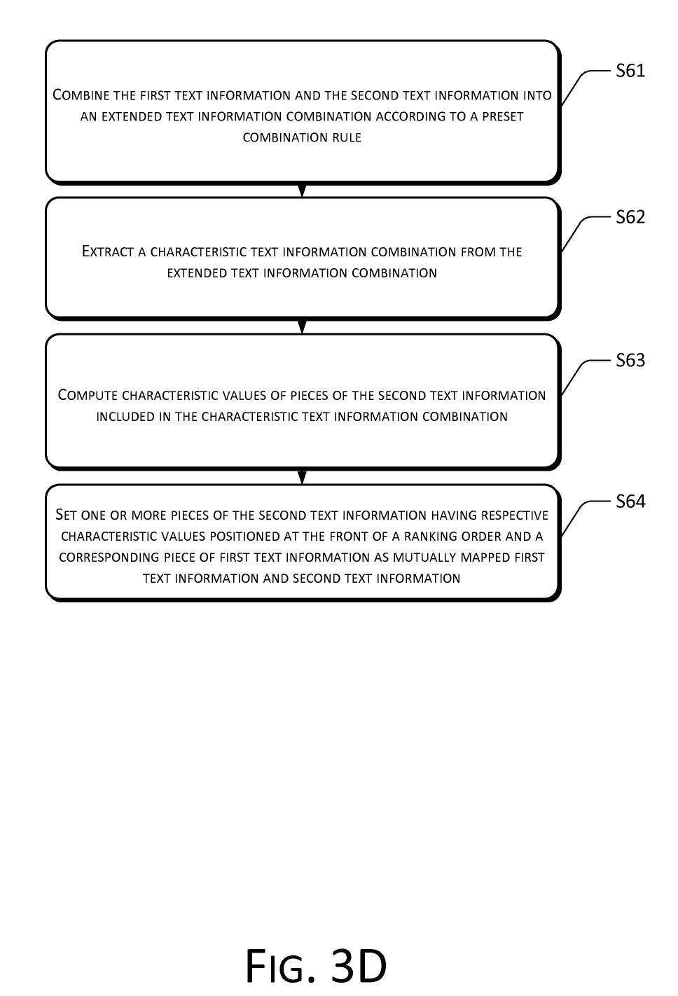

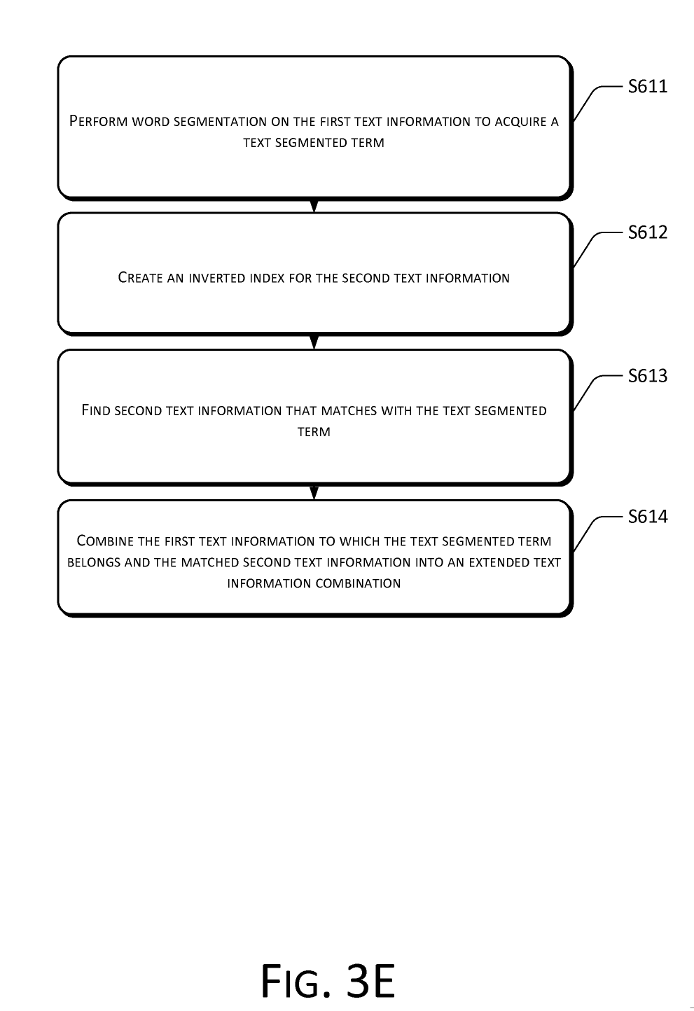

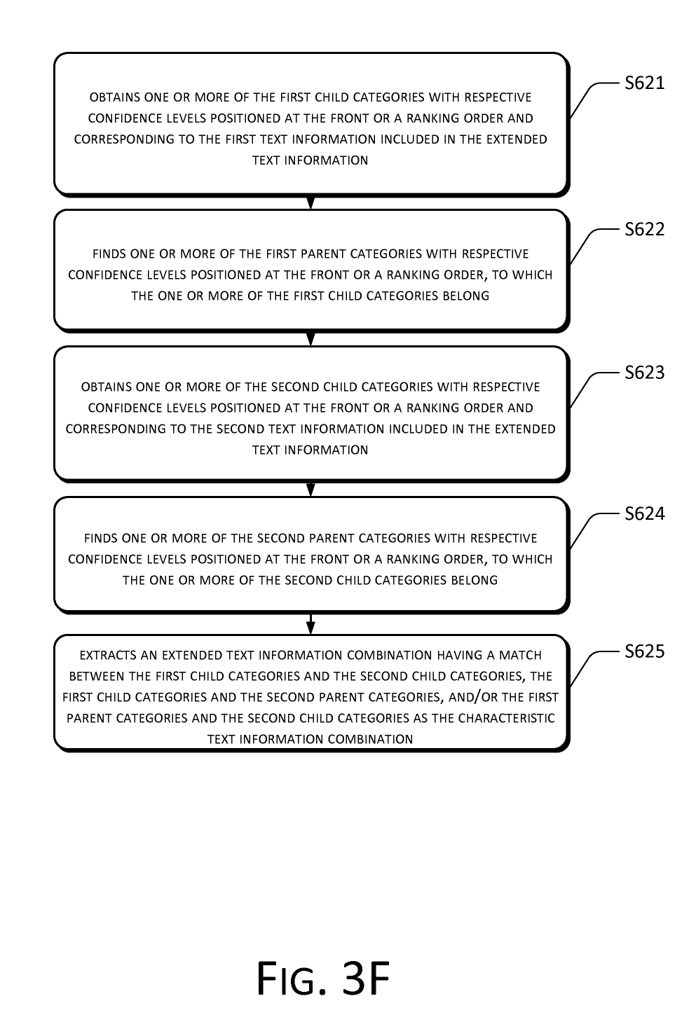

FIG. 3A illustrates a flowchart of an example method of pushing a business object according to the present disclosure. The method 300 may include the following blocks:

Block 301 receives first text information submitted from a client device.

Block 302 determines second text information to which the first text information is mapped, the second text information corresponding to a business object.

Block 303 pushes the business object to the client device.

A mapping relationship between the first text information and the second text information is determined using an approach as follows (as shown in FIG. 3B):

Sub-block S41 obtains a first text information set and a second text information set to be matched. The first text information set may include a finite amount of first text information, and the second text information set may include a finite amount of second text information.

Sub-block S42 finds one or more pieces of the finite amount of second text information which is matched with each piece of the finite amount of first text information according to a preset rule.

In an exemplary embodiment of the present disclosure, block 302 may include sub-blocks as follows (FIG. 3C):

Sub-block S51 computes the second text information to which the first text information is mapped on-line.

In an application of the embodiment of the present disclosure, in a scenario wherein a data volume of second text information is small, i.e., a data volume for computing a mapping relationship between first text information and second text information is small, the mapping relationship may be computed on-line directly (i.e., through sub-block S41-sub-block S42).

An advertisement system for electronic commerce is used as an example. When a user inputs a query, the advertisement system may query on-line directly and traverse all bid term sets, compute each maximum revenue index RPM1 between a query term and a candidate bid term in real time, select an optimal bid term for returning to the advertisement system, and push advertisement data in a PID (Position ID, i.e., ID of a region for presenting an advertisement) region of the advertisement system. For example, an advertisement region in search results on the left side of a search page, an advertisement recommendation region on the right side of the search page and an advertisement region at the bottom of the search page belong to different PID regions.

In another exemplary embodiment of the present disclosure, block 302 may include the following sub-block:

Sub-block S52 finds second text information to which the first text information is mapped from a preset mapping relationship dictionary, where the mapping relationship dictionary may be a dictionary that is generated by computing the second text information to which the first text information is mapped off-line.

In a scenario wherein a data volume of second text information is large, i.e., a data volume for computing a mapping relationship between first text information and second text information is large, the mapping relationship may be computed off-line (i.e., sub-block S41 to sub-block S42). In an implementation, the embodiment of the present disclosure may also acquire all <query, bid term> which satisfy conditions in advance according to a preset time rule (such as at regular time intervals), and creates a dictionary for online query service.

An advertisement system of a certain electronic commerce website is used as an example. For a total Cartesian computation that involves all query term sets and all bid term sets B, a total computation amount is 40000 billion times (10 million queries*4 million bid terms) daily. Thus, a distributed cloud computation platform such as hadoop may be employed for performing the computation.

Hadoop mainly includes two distributed parts. One is a distributed file system HDFS, and another is a distributed computation framework, i.e., MapReduce. A task process of MapReduce is divided into two processing stages: a Map stage and a Reduce stage. Each stage uses key/value pairs as an input and an output, a type thereof being selected by a user. The user also needs to specifically define two functions: a map function and a reduce function. The map function converts data (key, value) inputted by the user into a set of intermediate key value pairs through a user-defined mapping process. The reduce function conducts a reduction processing on the intermediate key value pairs that are generated temporarily. Rule(s) for reduction is/are also defined by the user, which is/are implemented through a designated reduce function, and the reduce function outputs a final result at the end. After being processed by the MapReduce framework, an output of the map function is finally distributed to the reduce function.

In this example, the computation may be completed within eight hours by using 32000 Map resources, thus satisfying the performance demand of daily update of <query, bid term>.

In an exemplary embodiment of the present disclosure, the first text information and the second text information have corresponding categories. Sub-block S42 may include the following sub-blocks (as shown in FIG. 3D):

Sub-block S61 combines the first text information and the second text information into an extended text information combination according to a preset combination rule.

Sub-block S62 extracts a characteristic text information combination from the extended text information combination, the characteristic text information combination being an extended text information combination formed by the first text information and the second text information having matched categor(ies).

Sub-block S63 computes characteristic values of pieces of the second text information included in the characteristic text information combination.

Sub-block S64 sets one or more pieces of the second text information having respective characteristic values positioned at the front of a ranking order and a corresponding piece of first text information as mutually mapped first text information and second text information.

In an exemplary embodiment of the present disclosure, sub-block S61 may include the following sub-blocks (as shown in FIG. 3E):

Sub-block S611 performs word segmentation on the first text information to acquire a segmented text term.

Sub-block S612 creates an inverted index for the second text information.

Sub-block S613 finds second text information that matches with the segmented text term.

Sub-block S614 combines the first text information to which the segmented text term belongs and the matched second text information into an extended text information combination.

In an exemplary embodiment of the present disclosure, sub-block S61 may further include the following sub-block:

Sub-block S615 performs a de-duplication processing on the second text information that matches with the segmented text term.

In this embodiment of the present disclosure, sub-block S614 may include the following sub-block:

Sub-block S6141 combines the first text information to which the segmented text term belongs and the de-duplicated second text information into an extended text information combination.

In an exemplary embodiment of the present disclosure, categories corresponding to the first text information may include first child categories and first parent categories, and categories corresponding to the second text information may include second child categories and second parent categories.

Sub-block S62 may include the following sub-blocks (as shown in FIG. 3F):

Sub-block S621 obtains one or more of the first child categories with respective confidence levels positioned at the front or a ranking order and corresponding to the first text information included in the extended text information.

Sub-block S622 finds one or more of the first parent categories with respective confidence levels positioned at the front or a ranking order, to which the one or more of the first child categories belong.

Sub-block S623 obtains one or more of the second child categories with respective confidence levels positioned at the front or a ranking order and corresponding to the second text information included in the extended text information.

Sub-block S624 finds one or more of the second parent categories with respective confidence levels positioned at the front or a ranking order, to which the one or more of the second child categories belong.

Sub-block S625 extracts an extended text information combination having a match between the first child categories and the second child categories, the first child categories and the second parent categories, and/or the first parent categories and the second child categories as the characteristic text information combination.

In a specific implementation, the second text information may have a corresponding business object.

A characteristic value of a piece of the second text information included in the characteristic text information combination may be computed using the following equation:

RPM1=ASN*CPC

where RPM1 is a characteristic value, ASN is a user depth corresponding to a business object, and CPC is a weight corresponding to the business object.

In an exemplary embodiment of the present disclosure, the finite amount of first text information may include query terms acquired in a certain time period, and the finite amount of second text information may include bid terms acquired in a certain period of time.

With respect to the embodiment of the present disclosure, since sub-block S41 to sub-block S42 are substantially similar to the example method of matching text information, this embodiment of the present disclosure is not described in detail herein. For a relevant part, reference may be made to the description of the method embodiment for characteristic extraction based on user behavior.

It should be noted that, for the ease of description, the method embodiments are all expressed as a combination of a sequence of actions. However, one skilled in the art should understand that the embodiments of the present disclosure are not limited to the described sequence of actions because some method blocks may be performed in a different order or in parallel based on the embodiments of the present disclosure. Furthermore, one skilled in the art should also know that the embodiments described in the specification are all exemplary embodiments, and some actions involved may not be needed by the embodiments of the present disclosure.

FIG. 4 illustrates a structural diagram of an example apparatus 400 of matching text information according to the present disclosure. The apparatus 400 may include the following modules:

a text information acquisition unit 401 to acquire a first text information set and a second text information set to be matched, the first text information set including a finite amount of first text information and the second text information set including a finite amount of second text information; and

a text information matching unit 402 to search and find one or more pieces of the finite amount of second text information which match with each piece of the finite amount of first text information according to a preset rule.

In an exemplary embodiment of the present disclosure, the first text information and the second text information have corresponding categories.

The text information matching unit 402 may include:

an extended text information combination formation module 403 to combine the first text information and the second text information into an extended text information combination according to a preset combination rule;

a characteristic text information combination extraction module 404 to extract a characteristic text information combination from the extended text information combination, the characteristic text information combination being an extended text information combination formed by the first text information and the second text information having one or more matched categories;

a characteristic value computation module 405 to compute characteristic values of pieces of the second text information included in the characteristic text information combination; and

a mapping relationship setting module 406 to set one or more pieces of the second text information having respective characteristic values positioned at the front of a ranking order and the corresponding first text information as first text information and second text information which is mutually mapped to each other.

In an exemplary embodiment of the present disclosure, the extended text information combination formation module 403 may include:

a word segmentation sub-module 407 to conduct word segmentation on the first text information to acquire a segmented text term;

an index sub-module 408 to establish an inverted index for the second text information;

a first searching sub-module 409 to find second text information which matches with the segmented text term from the inverted index; and

a formation sub-module 410 to combine the first text information to which the segmented text term belongs and the matched second text information into the extended text information combination.

In an exemplary embodiment of the present disclosure, the extended text information combination formation module 403 may further include the following sub-modules:

a de-duplication sub-module 411 to de-duplicate the second text information which matches with the segmented text term.

The formation sub-module 410 may further include the following sub-module:

a de-duplication combination sub-module 412 to combine the first text information to which the segmented text term belongs and the de-duplicated second text information into the extended text information combination.

In an exemplary embodiment of the present disclosure, categories corresponding to the first text information may include first child categories and first parent categories, and categories corresponding to the second text information may include second child categories and second parent categories.

The characteristic text information combination extraction module 404 may include the following sub-modules:

a first acquisition sub-module 413 to acquire one or more of the first child categories positioned at the front of an order of confidence levels and corresponding to the first text information included in the extended text information;

a second searching sub-module 414 to search one or more of the first parent categories positioned at the front of an order of confidence levels, to which the one or more of the first child categories belong;

a second acquisition sub-module 415 to acquire one or more of the second child categories positioned at the front of an order of confidence levels and corresponding to the second text information included in the extended text information;

a third searching sub-module 416 to search one or more of the second parent categories positioned at the front of an order of confidence levels, to which the one or more of the second child categories belong; and

an extraction sub-module 417 to extract an extended text information combination having a match between the first child categories and the second child categories, the first child categories and the second parent categories, and/or the first parent categories and the second child categories as the characteristic text information combination.

In an exemplary embodiment of the present disclosure, the second text information may have a corresponding business object.

A characteristic value of a piece of the second text information included in the characteristic text information combination may be computed using the following equation:

RPM1=ASN*CPC

where RPM1 is a characteristic value, ASN is a user depth corresponding to a business object, and CPC is a weight corresponding to the business object.

In an exemplary embodiment of the present disclosure, the finite amount of first text information may include queries acquired in a certain time period, and the finite amount of second text information may include bid terms acquired in a certain period of time.

In an embodiment, the apparatus 400 may further include one or more computing devices. For example, the apparatus 400 includes one or more processors (CPU) 418, an input/output interface 419, a network interface 420 and memory 421.

The memory 421 may be a form of computer readable media, e.g., a non-permanent storage device, random-access memory (RAM) and/or a nonvolatile internal storage, such as read-only memory (ROM) or flash RAM. The memory is an example of computer readable media. The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

Additionally, in an embodiment, the memory 421 may include program units 422 and program data 423. The program units 422 may include one or more foregoing units, modules and sub-modules. For example, the program units 422 may include the text information acquisition unit 401 and text information matching unit 402. The text information matching unit 402 may include the extended text information combination formation module 403 (which may include the word segmentation sub-module 407, the index sub-module 408, the first searching sub-module 409, the formation sub-module 410 (which may include de-duplication combination sub-module 412) and de-duplication sub-module 411), the characteristic text information combination extraction module 404 (which may include the first acquisition sub-module 413, second searching sub-module 414, the second acquisition sub-module 415, the third searching sub-module 416 and extraction sub-module 417), the characteristic value computation module 405 and the mapping relationship setting module 406.

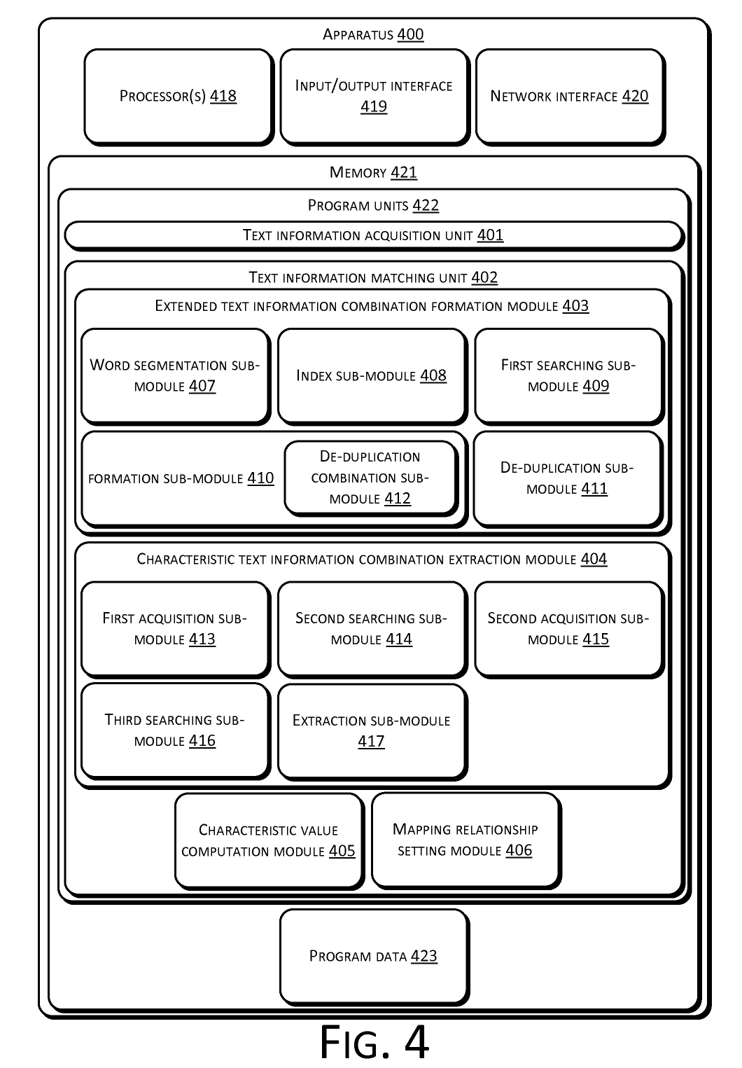

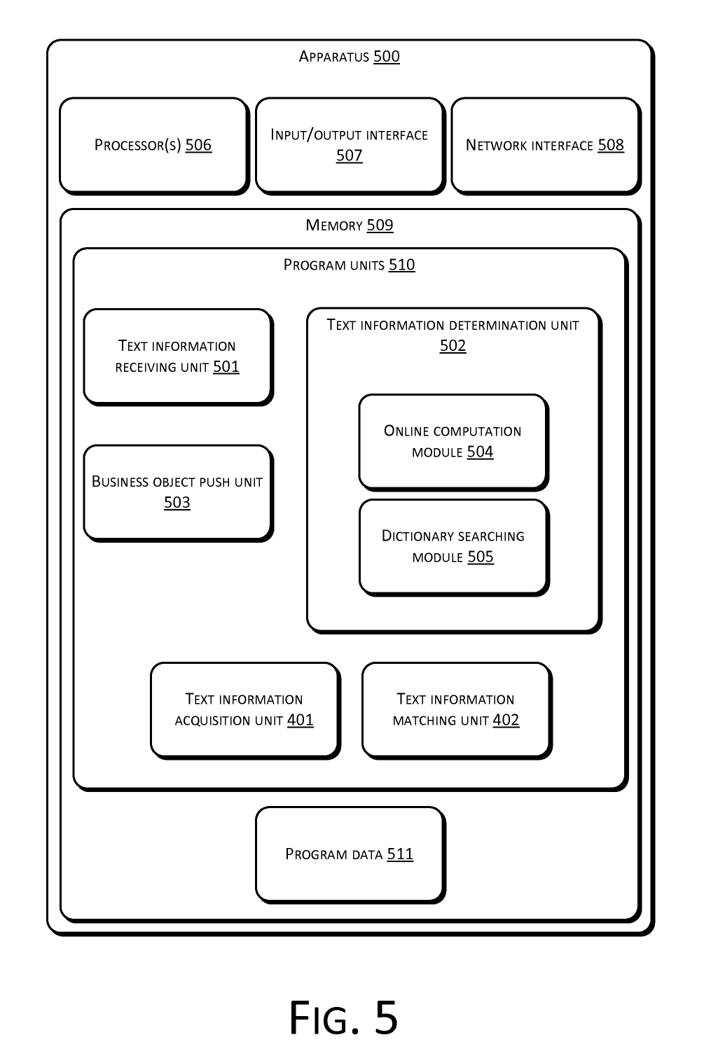

FIG. 5 illustrates a structural diagram of an example apparatus 500 of pushing a business object according to the present disclosure. The apparatus 500 may include a text information receiving unit 501 to receive first text information submitted by a client side, a text information determination unit 502 to determine second text information to which the first text information is mapped, the second text information corresponding to a business object, and a business object push unit 503 to push the business object to the client side, where a mapping relationship between the first text information and the second text information may be determined by invoking the text information acquisition unit 401 and the text information matching unit 402 as described in the foregoing embodiments.

In an exemplary embodiment of the present disclosure, the text information determination unit 502 may include an online computation module 504 to compute the second text information to which the first text information is mapped on-line.

In an exemplary embodiment of the present disclosure, the text information determination unit 502 may include a dictionary searching module 505 to search and find the second text information to which the first text information is mapped from a preset mapping relationship dictionary, where the mapping relationship dictionary is a dictionary generated by computing the second text information to which the first text information is mapped off-line.

In an embodiment, the apparatus 500 may further include one or more computing devices. For example, the apparatus 500 includes one or more processors 506, an input/output interface 507, a network interface 508 and memory 509, which may be a form of computer readable media. The memory 509 may include program units 510 and program data 511.

The apparatus embodiments are described relatively simple because of their substantial similarities to the method embodiments. For related parts, reference may be made to the method embodiments.

The embodiments in this specification are described in a progressive manner, and a focus of each embodiment is different from those of the other embodiments. For same or similar parts among the embodiments, reference may be made to one another.

Each embodiment in the specification is described in a progressive manner. Emphasis of each embodiment is different from other embodiments, and the same or similar part of each embodiment can be referenced with each other.

One skilled in the art should understand that the embodiments of the present disclosure can be provided as a method, an apparatus or a product of a computer program. Therefore, the present disclosure can be implemented as an embodiment of only hardware, an embodiment of only software or an embodiment of a combination of hardware and software. Moreover, the present disclosure can be implemented as a product of a computer program that can be stored in one or more computer readable storage media (which includes but is not limited to, a magnetic disk, a CD-ROM or an optical disk, etc.) that store computer-executable instructions.

The present disclosure is described in accordance with flowcharts and/or block diagrams of the exemplary methods, terminal apparatuses (systems) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing terminal device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing terminal device.

Such computer program instructions may also be stored in a computer readable memory device which may cause a computer or another programmable data processing mobile apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing terminal apparatus, so that a series of operations may be executed by the computer or the other data processing terminal apparatus to generate a computer implemented process. Therefore, the instructions executed by the computer or the other programmable apparatus may be used to implement one or more processes of the flowcharts and/or one or more blocks of the block diagrams.

Although the exemplary embodiments of the present disclosure have been described herein, one skilled in the art can make changes and modifications to these embodiments after understanding the fundamental creative concept of the present disclosure. The claims attached herein intend to include the exemplary embodiments and all changes and modifications covered by the embodiments of the present disclosure.

Finally, it should be noted that terms such as “first” and “second” are only used for differentiating an entity or operation from another entity or operation, but do not necessarily request or imply any existence of this type of real relationship or ordering between the entities or operations. Moreover, terms such as “comprise”, “include” or any other variations thereof are meant to cover the non-exclusive inclusions. The process, method, product or terminal apparatus that includes a series of elements not only includes those elements, but also includes other elements that are not explicitly listed, or further includes elements that already existed in such process, method, product or terminal apparatus. In a condition without further limitations, an element defined by the phrase “include a/an . . . ” does not exclude any other similar elements from existing in the process, method, product or terminal apparatus.

Detailed descriptions of a method of matching information, a method of pushing a business object, and apparatuses of matching information and pushing a business object in accordance with the present disclosure have been described above. The specification explains the principles and implementations of the present disclosure using specific embodiments. The foregoing embodiments are merely used for helping to understand the methods and core concepts of the present disclosure. Also, based on the concepts of the present disclosure, one of ordinary skill in the art may change specific implementations and scope of applications. In short, the present specification shall be not construed as limitations to the present disclosure.

What is claimed is:

1. A method implemented by one or more computing devices, the method comprising:
acquiring a first text information set and a second text information set to be matched, the first text information set including a finite amount of first text information and the second text information set including a finite amount of second text information; and
identifying one or more pieces of the finite amount of second text information that match with each piece of the finite amount of first text information according to a preset rule.

2. The method of claim 1, wherein identifying the one or more pieces of the finite amount of second text information comprises:
combining the first text information and the second text information as an extended text information combination according to a preset combination rule;
extracting a characteristic text information combination from the extended text information combination, the characteristic text information combination being a combination of extended text information formed from at least one piece of the first text information and at least one piece of the second text information having at least one matched category;
computing characteristic values of a plurality of pieces of the second text information included in the characteristic text information combination; and
setting one or more pieces of the second text information having respective characteristic values corresponding to first N highest values and a corresponding piece of the first text information as mutually mapped first text information and second text information, wherein N is a positive integer.

3. The method of claim 2, wherein the second text information is associated with a corresponding business object, and a characteristic value of a piece of the second text information included in the characteristic text information combination is computed via an equation: RPM1=ASN*CPC, wherein, RPM1 is the characteristic value, ASN is a user depth corresponding to the business object and CPC is a weight corresponding to the business object.

4. The method of claim 1, further comprising combining the first text information and the second text information as an extended text information combination according to a preset combination rule, combining the first text information and the second text information comprising:
conducting word segmentation for the first text information to acquire at least one segmented text term;
establishing an inverted index for the second text information;
identifying second text information matching with the segmented text term from the inverted index; and
combining the first text information to which the segmented text term belongs and the matched second text information as the extended text information combination.

5. The method of claim 1, further comprising combining the first text information and the second text information as an extended text information combination according to a preset combination rule, combining the first text information and the second text information comprising:
conducting word segmentation for the first text information to acquire at least one segmented text term;
establishing an inverted index for the second text information;
identifying second text information matching with the segmented text term from the inverted index;
de-duplicating the matched second text information; and
combining the first text information to which the segmented text term belongs and the de-duplicated second text information as the extended text information combination.

6. The method of claim 1, wherein categories corresponding to the first text information comprise first child categories and first parent categories, and categories corresponding to the second text information comprise second child categories and second parent categories.

7. The method of claim 6, wherein finding the one or more pieces of the finite amount of second text information comprises:
combining the first text information and the second text information as an extended text information combination according to a preset combination rule;
acquiring one or more of the first child categories positioned at the front of a respective ranking order of confidence levels and corresponding to the first text information included in the extended text information combination;
searching one or more of the first parent categories positioned at the front of a respective ranking order of confidence levels, to which the one or more of the first child categories belong;
acquiring one or more of the second child categories with positioned at the front of a respective ranking order of confidence levels and corresponding to the second text information included in the extended text information combination;
searching one or more of the second parent categories positioned at the front of a respective ranking order of confidence levels, to which the one or more of the second child categories belong; and
extracting an extended text information combination having a match between the first child categories and the second child categories, the first child categories and the second parent categories, and/or the first parent categories and the second child categories as a characteristic text information combination.

8. The method of claim 1, wherein the finite amount of the first text information comprises queries acquired in a first predetermined time period, and the finite amount of the second text information comprises bid terms acquired in a second predetermined time period.

9. One or more computer-readable media storing executable instructions that, when executed by one or more processors, cause the one or more processors to perform acts comprising:
receiving first text information submitted by a client device;
determining second text information to which the first text information is mapped based at least in part on a mapping relationship between the first text information and the second text information, the second text information corresponding to a business object; and
pushing the business object to the client device when the second text information is searched by a user associated with the client device.

10. The one or more computer-readable media of claim 9, the acts further comprising:
acquiring a first text information set and a second text information set to be matched, the first text information set comprising a finite amount of first text information and the second text information set comprising a finite amount of second text information; and
finding one or more pieces of the finite amount of second text information which is matched with each piece of the finite amount of first text information according to a preset rule.

11. The one or more computer-readable media of claim 9, wherein determining the second text information to which the first text information is mapped comprises computing the second text information to which the first text information is mapped on-line.

12. The one or more computer-readable media of claim 9, wherein determining the second text information to which the first text information is mapped comprises searching the second text information to which the first text information is mapped from a preset mapping relationship dictionary, the mapping relation dictionary comprising a dictionary generated by computing the second text information to which the first text information is mapped off-line.

13. An apparatus comprising:
one or more processors;
memory;
a text information acquisition unit stored in the memory and executable by the one or more processors to acquire a first text information set and a second text information set to be matched, the first text information set comprising a finite amount of first text information and the second text information set comprising a finite amount of second text information; and
a text information matching unit stored in the memory and executable by the one or more processors to search and identify one or more pieces of the finite amount of second text information which match with each piece of the finite amount of first text information according to a preset rule.

14. The apparatus of claim 13, wherein the text information matching unit comprises:
an extended text information combination formation module to combine the first text information and the second text information into an extended text information combination according to a preset combination rule;
a characteristic text information combination extraction module to extract a characteristic text information combination from the extended text information combination, the characteristic text information combination comprising an extended text information combination formed by first text information and second text information having at least one matched category;
a characteristic value computation module to compute characteristic values of a plurality of pieces of second text information included in the characteristic text information combination; and
a mapping relationship setting module to set one or more pieces of the second text information with respective characteristic values ranked at the front and a corresponding piece of the first text information as first text information and second text information mutually mapped to each other.

15. The apparatus of claim 14, wherein the extended text information combination formation module comprises:
a word segmentation sub-module to conduct word segmentation on the first text information to acquire a segmented text term;
an index sub-module to establish an inverted index for the second text information;
a first searching sub-module to search and find second text information which is matched with the segmented text term from the inverted index; and
a formation sub-module to combine the first text information to which the segmented text term belongs and the matched second text information into the extended text information combination.

16. The apparatus of claim 15, wherein the extended text information combination formation module further comprises: a de-duplication sub-module to conduct a de-duplication processing on the second text information which is matched with the segmented text term, and wherein the formation sub-module comprises a de-duplication combination sub-module to combine the first text information to which the segmented text term belongs and the de-duplicated second text information into the extended text information combination.

17. The apparatus of claim 14, wherein categories corresponding to the first text information comprise first child categories and first parent categories, categories corresponding to the second text information comprise second child categories and second parent categories, and the characteristic text information combination extraction module comprises:
a first acquisition sub-module to acquire one or more of the first child categories with respective confidence levels ranked at the front and corresponding to the first text information included in the extended text information combination;
a second searching sub-module to search one or more of the first parent categories with respective confidence levels ranked at the front, to which the one or more of the first child categories belong;
a second acquisition sub-module to acquire one or more of the second child categories with respective confidence levels ranked at the front and corresponding to the second text information included in the extended text information combination;
a third searching sub-module to search one or more of the second parent categories with respective confidence levels at the front, to which the one or more of the second child categories belong; and
an extraction sub-module to extract an extended text information combination which having a match between the first child categories and the second child categories, the first child categories and the second parent categories, and/or the first parent categories and the second child categories as the characteristic text information combination.

18. The apparatus of claim 14, wherein the second text information has a corresponding business object, and wherein a characteristic value of a piece of the second text information included in the characteristic text information combination is computed via an equation: RPM1=ASN*CPC, wherein, RPM1 is the characteristic value, ASN is a user depth corresponding to the business object, and CPC is a weight corresponding to the business object.

19. The apparatus of claim 13, wherein the finite amount of first text information comprises query terms acquired in a first predetermined period of time and the finite amount of second text information comprises bid terms acquired in a second predetermined period of time.

20. The apparatus of claim 13, further comprising:
a text information receiving unit to receive first text information submitted from a client side;
a text information determination unit to determine second text information to which the received first text information is mapped, the mapped second text information corresponding to a business object; and
a business object push unit to push the business object to the client side.
